(19) United States
(12) Patent Application Publication
(10) Pub. No.: US 2004/0204665 A1
(43) Pub. Date: Oct. 14, 2004

(54) Massage cushion

(76) Inventor: Julian Chu, San Chung City (TW)

Correspondence Address: Chang Chia Wei, P.O. Box 25-7, Kaohsiung City 811, TW

(21) Appl. No.: 10/419,917

(22) Filed: Apr. 9, 2003

(51) Int. Cl. A61H 7/00

(52) U.S. Cl. 601/134; 601/136; 601/28

(57) ABSTRACT

A massage cushion has a body. A plurality of first protrusions and a plurality of second protrusions are formed on a side of the body. Each first protrusion and each second protrusion are made of the same material. A diameter of a root portion of each first protrusion is greater than that of a root portion of each second protrusion. The first protrusions and the second protrusions are so constructed that the buttocks of a person sitting on the side of the body are in contact with at least one of the first protrusions and at least one of the second protrusions. The first protrusions on the body cover an area that corresponds to an area occupied by buttocks of a person sitting on the side of the body.

### BACKGROUND OF THE INVENTION

1. Field of the Invention

The present invention relates to a massage cushion. In particular, the present invention relates to a massage cushion for buttocks.

2. Description of the Related Art

One would feel tired through hard work or repeated movements. For a driver driving through a long distance, the body would feel sore in the buttocks due to poor blood circulation and stress. Some drivers put a cushion to relieve the discomfort at the buttocks. A typical cushion 1 is shown in FIG. 1 of the drawings and includes a body 11 with a plurality of identical protrusions 12 on a side thereof for improving the blood circulation in the buttocks. Some doctors also recommend use of massage devices to proceed with medical massage to heal a patient that has a stroke or muscular injury so as to improve the circulation and to stimulate the body. In some cases, the massage devices are used as a tool for consuming calorie for the purpose of losing weight. However, as illustrated in FIG. 2, some of the protrusions 12 are bent and thus provide less stimulating effect. The massage effect deteriorates accordingly.

### SUMMARY OF INVENTION

An object of the present invention is to provide a massage cushion having a body. A plurality of first protrusions and a plurality of second protrusions are formed on a side of the body. Each first protrusion and each second protrusion are made of the same material. A diameter of a root portion of each first protrusion is greater than that of a root portion of each second protrusion. The first protrusions and the second protrusions are so constructed that the buttocks of a person sitting on the side of the body are in contact with at least one of the first protrusions and at least one of the second protrusions.

In an embodiment of the invention, the length of each first protrusion is substantially equal to that of each second protrusion. An area of a distal end of each first protrusion is equal to that of a distal end of each second protrusion. The first protrusions on the body cover an area that corresponds to an area occupied by buttocks of a person sitting on the side of said body. The area covered by the first protrusions represents a figure of a butterfly.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view of a conventional massage cushion.

FIG. 2 is a schematic view illustrating use of the conventional massage cushion.

FIG. 3 is a perspective view of a massage cushion in accordance with the present invention.

FIG. 3A is an enlarged view of a circled portion in FIG. 3.

FIG. 4 is a perspective view of a modified embodiment of the massage cushion in accordance with the present invention.

FIG. 5 is a schematic side view illustrating use of the massage cushion in accordance with the present invention.

FIG. 6 is a perspective view of the other side of the massage cushion in accordance with the present invention.

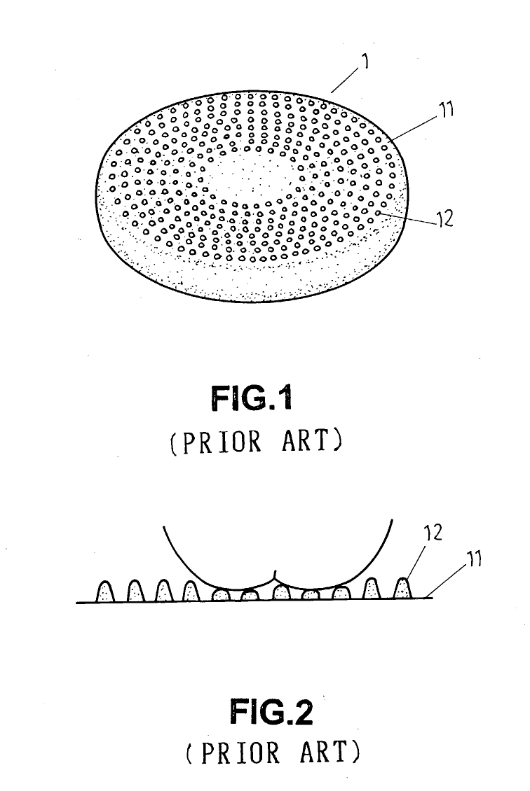

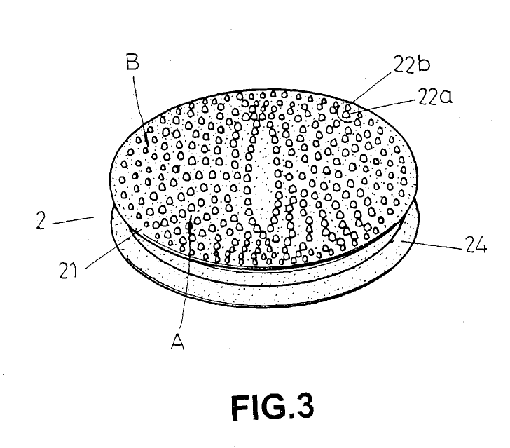

### DETAILED DESCRIPTION OF THE PREFERRED EMBODIMENT

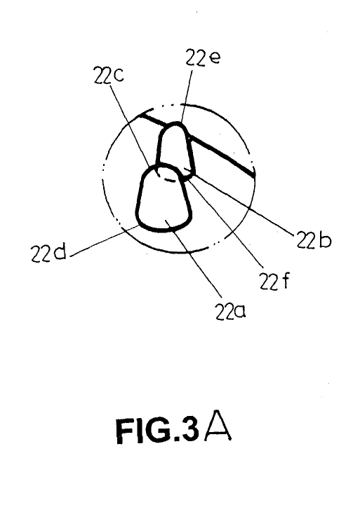

Referring to FIG. 3, a massage cushion in accordance with the present invention is designated by “2” and includes a body 21. Water, air, or stuffing material may be fitted into an interior of the body 21 so as to provide the body 21 with resilience. An annular groove 24 may be defined in a peripheral side of the body 21 to increase the lateral strength.

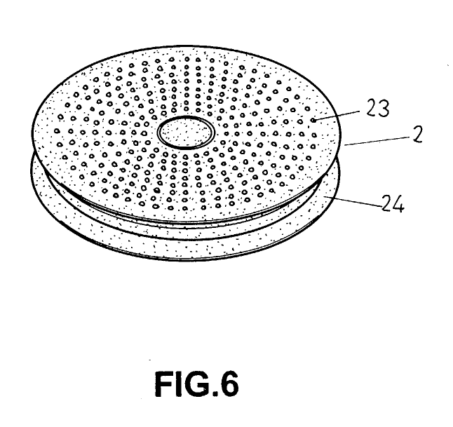

On a side of the body 21 there are provided a plurality of first protrusions 22a and a plurality of second protrusions 22b. Each first protrusion 22a and each second protrusion 22b are made of the same material. Nevertheless, a diameter of a root portion 22d of each first protrusion 22a is greater than that of a root portion 22f of each second protrusion 22b. Preferably, an area of a distal end 22c of each first protrusion 22a is equal to that of a distal end 22e of each second protrusion 22b. Each first protrusion 22a has a length is substantially equal to that of each second protrusion 22b; namely, the length of each first protrusion 22a is exactly the same as or slightly greater or less than that of each second protrusion 22b. If required, a plurality of small protrusions 23 may be formed on the other side of the body 21, as shown in FIG. 6.

As illustrated in FIG. 3, the first protrusions 22a on the body 21 cover an area A that corresponds to an area occupied by the buttocks of a person sitting on the side of the body 21. The second protrusions 22b on the body 21 cover an area B.

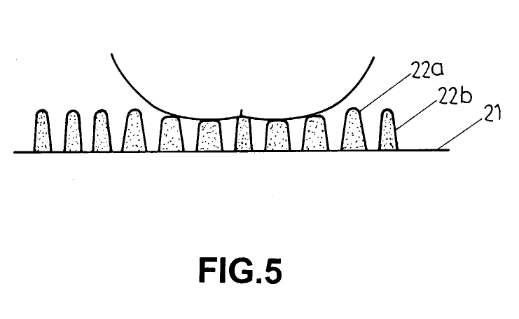

The first protrusions 22a and the second protrusions 22b are so constructed that the buttocks of a person sitting on the side of the body are in contact with at least one of the first protrusions 22a and at least one of the second protrusions 22b, as shown in FIG. 5.

As illustrated in FIG. 3A, since the root portion 22f of each second protrusion 22b has a diameter smaller than that of the root portion 22d of each first protrusion 22a, the seated person (FIG. 5) would feel more intensive stimulation in the area B. The blood circulation is improved.

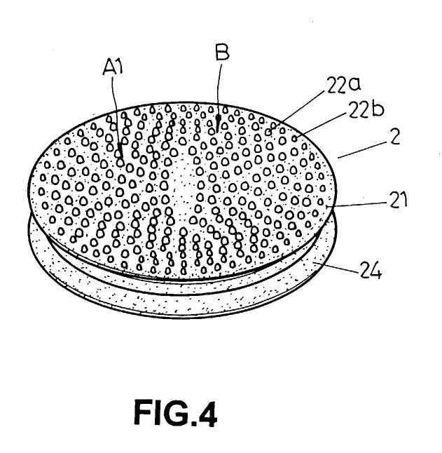

FIG. 4 illustrates a modified embodiment of the invention, wherein the first protrusions 22 cover an area A1 that represents a figure of a butterfly.

Although the invention has been explained in relation to its preferred embodiment, it is to be understood that many other possible modifications and variations can be made without departing from the scope of the invention as hereinafter claimed.

What is claimed is:

1. A massage cushion having a body, a plurality of first protrusions and a plurality of second protrusions being formed on a side of said body, each said first protrusion and each said second protrusion being made of the same material, a diameter of a root portion of each said first protrusion being greater than that of a root portion of each said second protrusion, said first protrusions and said second protrusions being so constructed that buttocks of a person sitting on said side of said body are in contact with at least one of said first protrusions and at least one of said second protrusions.

2. The massage cushion as claimed in claim 1, wherein said first protrusions on said body cover an area that corresponds to an area occupied by buttocks of a person sitting on said side of said body.

3. The massage cushion as claimed in claim 1, wherein said area covered by said first protrusions represents a figure of a butterfly

4. The massage cushion as claimed in claim 1, wherein each said first protrusion has a length substantially equal to that of each said second protrusion.

5. The massage cushion as claimed in claim 1, wherein an area of a distal end of each said first protrusion is equal to that of a distal end of each said second protrusion.
